(19) United States
(12) Patent Application Publication
(10) Pub. No.: US 2007/0213514 A1
(43) Pub. Date: Sep. 13, 2007

(54) METHOD FOR PRODUCING LIQUID ADJUSTMENTS OF BASIC AZO DYES

(75) Inventors: Michael Schmitt, Worms (DE); Jurgen Decker, Dudenhofen (DE); Helmut Reichelt, Neustadt (DE); Gerd Rollar, Frankenthal (DE); Armin Diefenbacher, Germersheim (DE); Hartwig Voss, Frankenthal (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/568,996

(22) PCT Filed: May 18, 2005
(86) PCT No.: PCT/EP05/05393

§ 371 Date: Nov. 13, 2006

(30) Foreign Application Priority Data
May 19, 2004 (DE) 102004025444.3

(51) Int. Cl. C09B 29/00

(52) U.S. Cl. 534/579

(57) ABSTRACT

A process for producing a liquid formulation of a basic azo dye from a phenylenediamine I, which may be alkyl or alkoxy substituted, by diazotizing and coupling in acidic solution comprises diazotizing the phenylenediamine with sodium nitrite in the presence of at least two organic acids comprising at least one first acid (A) having a pk_{A} value of ≦40 and at least a second acid (B) having a pK_{A} value ≧4.1 and performing a nanofiltration after the coupling has ended.

The present invention concerns a novel process for producing liquid formulations of basic azo dyes from optionally substituted phenylenediamine by diazotizing and coupling in acidic solution.

EP-A-36 553 discloses diazotizing and coupling optionally substituted m-phenylenediamine in a carboxylic acid solution. The diazotizing reagent used is sodium nitrite and also neopentylglycol dinitrite. m-Phenylenediamine is initially charged in acetic acid and diazotized and coupled by metered addition of sodium nitrite. The dye solution thus obtained has but a limited shelf life owing to the fairly high salt content. The reference further describes the diazotization with neopentylglycol dinitrite in a mixture of formic acid and acetic acid. The disadvantage here is the high cost and inconvenience in terms of apparatus and safety precautions which the handling of organic nitrites entails.

DE-A-37 13 617 teaches the production of liquid formulations of basic azo dyes from optionally substituted m-phenylenediamine by reaction with 0.76 to 0.95 mol of nitrite based on 1 mol of m-phenylenediamine and subsequent heating of the reaction mixture. Dyes thus prepared are notable for good bath exhaustion. However, the storage stability problem has not been solved here either.

DE-A-37 13 618, finally, describes the subsequent reaction with 0.1 to 1.2 mol of formic acid and thermal aftertreatment of the reaction mixture of the diazotization of m-phenylenediamine with neopentylglycol dinitrite and coupling onto itself. This approach leads to dyes which do not redden when used for dyeing paper in an acidic medium. However, the use of an organic nitrite is problematic here as well.

The present invention therefore has for its object to develop a process for producing liquid formulations of azo dyes based on a phenylenediamine that avoids the abovementioned disadvantages and yet does not require any handling of solid intermediates.

We have found that this object is achieved by a process for producing a liquid formulation of a basic azo dye from a phenylenediamine I, which may be alkyl or alkoxy substituted, by diazotizing and coupling in acidic solution, which comprises diazotizing the phenylenediamine I with sodium nitrite in the presence of at least two organic acids comprising at least one first acid (A) having a pk_{A} value of ≦4.0 and at least a second acid (B) having a pK_{A} value ≧4.1 and performing a nanofiltration after the coupling has ended.

Nanofiltration serves to desalt the dye solution and, if appropriate, concentrate it. It was found that, surprisingly, the crude dye solutions obtained according to the present invention can be desalted by nanofiltration without incurring unacceptable losses of dye. Moreover, the dyes prepared by the process according to the present invention are notable for good stability in storage.

The starting material used for the azo dyes is phenylenediamine I, which is optionally C₁-C₄-alkyl or C₁-C₄-alkoxy substituted. Preference is given to using unsubstituted phenylenediamine or phenylenediamine which is ring substituted by a methyl or methoxy group. Specific examples are m-phenylenediamine, 1-methyl-2,4-diaminobenzene, 1-methyl-2,6-diaminobenzene and 1-methoxy-2,4-diaminobenzene. It is also possible to use mixtures of various phenylenediamines.

It may be preferable in some cases to replace up to 40 mol % of the respective phenylenediamine by aniline, which is optionally C₁-C₄-alkyl or C₁-C₄-alkoxy substituted. When these monoamines and unsubstituted aniline in particular are used, the amount of nitrite used is reduced accordingly.

Useful acids (A) having a pk_{A} value of ≦4.0 include methanesulfonic acid and preferably formic acid.

Useful acids (B) having a pK_{A} value ≧4.1 include for example C₂-C₄-alkanoic acids, which may optionally be suitably substituted. Particular preference is given to propionic acid and especially acetic acid.

As well as the acids, the solution medium may further comprise water or other water-soluble solvents such as alkanols, glycols, glycol ethers, amides or esters, e.g., methanol, ethanol, propanol, isopropanol, ethylene glycol, diethylene glycol, propylene glycol, dipropylene glycol, ethylene glycol monoethyl ether, ethylene glycol monopropyl ether, ethylene glycol monobutyl ether, N,N-dimethylformamide, N-methylpyrrolidone or else gamma-butyrolactone. Preferably water is the only solution medium as well as the acids.

The solution medium used for the diazotization and coupling advantageously comprises about 3% to 30% by weight and preferably 10% to 25% by weight of organic acid, the rest being water.

The mixing ratios of the reactants and solvents are advantageously chosen such that the basic azo dye solutions produced according to the present invention have a pre-nanofiltration dye content of about 4% to 10% by weight. After desalting and concentrating by nanofiltration, the liquid formulations obtained will typically have a dye content of about 12-25% by weight.

The process of the present invention is advantageously carried out by directly introducing the mixture of the two acids (A) and (B) as the initial charge or else preferably adding one of the two acids (A) or (B) completely or partially by metered addition. It is possible in this connection to initially charge the bulk of the stronger acid (A) in order that the pH may be kept as low as possible at the start of the diazotization. In a preferred version, the reaction mixture comprises at least 80mol % of acid (A), based on the total amount of acid at the start of the diazotization, at the start of the diazotization. Preference is likewise given to a version wherein the fraction of acid (A) is 20 to 50 mol % based on the total amount of acid used (A+B). Particular preference is given to a process which combines the two versions, so that one starts with a reaction mixture comprising at least 80 mol % of acid (A) and the acid (A) fraction is in the range from 20 to 50 mol % based on the total amount of acid used. This acid ratio which changes in the course of the reaction, is achieved by portionwise or continuous metered addition of acid (B). The most advantageous acid gradient can be determined by simple tests by varying the rate of metered addition.

The phenylenediamine I is preferably dissolved in the acid (B) and metered at the same time as a typically aqueous solution of the diazotizing agent. During the reaction, the pH of the mixture rises, bringing the coupling reaction to eventual completion. If appropriate, it is also possible to meter a portion of the acid quantity (A) or (B) independently of the phenylenediamine I.

It is advantageous to use from 0.50 to 0.90 mol of diazotizing agent and preferably from 0.60 to 0.80 mol of diazotizing agent per 1 mol of phenylenediamine I.

Preferably, a solution of the optionally substituted phenylenediamine I in acid (B) is metered into the reaction mixture concurrently to and hence simultaneously with the diazotizing agent, generally using a separate feed point.

The addition of the sodium nitrite and of the phenylenediamine take place at a temperature in the range from −10 to +25° C. and preferably in the range from 0 to 15° C. On completion of the addition the reaction mixture in a preferred version is stirred at temperatures from 30° C. to 50° C. for a period in the range from 0.5 to 5 hours and subsequently heated if appropriate to a temperature in the range from 60° C. to the boiling temperature of the reaction mixture.

The dyes prepared by the process according to the present invention are generally not unitary dyes, but are mixtures of mono-, bis- and polyazo dyes, since the diamines used as a starting material and products based thereon, are not just singly diazotized and couplable but multiply. The main components in this context have the following formula: 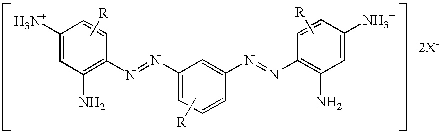
where R is hydrogen, C₁-C₄-alkyl or C₁-C₄-alkoxy and X is the counterion of an acid, typically the organic acid serving as a solvent.

Similar products to the dyes obtained by the process of the present invention are known for example under the trade names of Bismarck Brown G and R or vesuvin or else described in EP-A-36 553. They are used for dyeing paper, particularly wastepaper, or leather or else for dyeing anionically modified fibers, for example acrylonitrile polymers. They can be blended with other basic dyes to achieve different hues, for example black.

The process of the present invention generally provides a crude dye solution whose dye content is in the range from 4% to 10% by weight. Such a solution can be directly nanofiltered. If a concentrated dye solution is present, it can be advantageous to dilute the mixture with water to a dye solution from 4% to 8% by weight in strength in order that higher flux rates may be achieved at filtration and hence the space-time yield may be increased. Removal of the permeate causes the mixture to become desalted and concentrated.

Membranes utilized in the membrane separation unit employed according to the present invention are preferably commercially available nanofiltration membranes having molecular weight cutoffs of 200 daltons to 2000 daltons and more preferably 200 daltons to 1000 daltons. Transmembrane pressures range from 1 to 50 bar at temperatures up to 100° C.

Higher transmembrane pressures generally lead to higher permeate fluxes. Higher temperatures lead in principle to higher permeate fluxes and therefore are preferred as long as the product does not decompose.

The membrane separation unit can utilize any membrane which is stable in the particular system under the requisite separating conditions. The separating layers of useful membranes can consist of organic polymers, ceramic, metal, carbon or combinations thereof, and have to be stable in the reaction medium and at the process temperature. For mechanical reasons, separating layers are generally supported by a single- or multi-layered porous substructure which consists of the same material as the separating layer or else of at least one different material than the separating layer. Examples are separating layers of ceramic and substructures of metal, ceramic or carbon; separating layers of carbon and substructures of metal, ceramic or carbon; separating layers of polymer and substructures of polymer, metal, ceramic or ceramic on metal. Polymeric separating layers used include for example polysulfone, polyethersulfone, polydimethylsiloxane (PDMS), polyetheretherketone, polyamide and polyimide.

Particular preference is given to inorganic membranes, especially membranes having ceramic separating layers. Compared with membranes having polymeric separating layers, these membranes achieve better salt passage and higher permeate flux. Ceramic separating layers include for example α-Al₂O₃, ZrO₂, TiO₂, SiC or mixed ceramic materials of construction.

The membranes are typically encased in pressure-resistant housings which permit separation between retentate (dye-rich residue) and permeate (dye-lean filtrate) at the pressure conditions required for separation. Membranes can be embodied in flat, tubular, multi-channel element, capillary or wound geometry, for which appropriate pressure housings which permit separation between retentate and permeate are available. Depending on area requirements, one membrane element can comprise plural channels. Moreover, plural of these elements can be combined in one housing to form a module. The cross-flow speed in the module varies with module geometry between 0.2 and 10 m/s. Typical values range from 0.2 to 0.4 m/s in the case of a wound geometry and from 1 to 6 m/s in the case of a tubular geometry.

A portion of the nanofiltration for desalting is preferably carried out as a diafiltration. In diafiltration, the removed permeate is wholly or partly replaced by suitable diafiltration medium. In the process of the present invention, the permeate is preferably replaced by an aqueous solution of an acid in order that the pH may be kept constant. Replacement of the permeate in the diafiltration step may be done portionwise or continuously. To achieve good salt removal in the process of the present invention it may often be preferable to concentrate by nanofiltration and then do the diafiltration. If appropriate, the sequence of concentration and diafiltration can be repeated.

In a preferred version, where the dye solution is recirculated and the pH is kept constant by continuous addition of acid (B), the amount of inorganic salts is reduced to <10% by weight based on the 100% pure dye in the diafiltration step using a total permeate quantity equal to 1 to 10 times the amount of recirculated dye solution. The as-nanofiltered dye solutions are typically from 12% to 25% by weight in strength.

When the generally desired fraction of acid (B) especially acetic acid of the dye solution has decreased too much, it is replenished to a value in the range from 5% to 30% by weight in a preferred version after the nanofiltration.

The process of the present invention provides basic azo dye solutions which can be further used directly as a liquid formulation.

If desired, the dye solutions are admixed with solubilizing additives. Such additives include for example water-miscible organic solvents such as C₁-C₄-alkanols, for example methanol, ethanol, propanol, isopropanol, butanol, isobutanol, sec-butanol or tert-butanol, carboxamides, such as N,N-dimethylformamide or N,N-dimethylacetamide, ketones or keto alcohols, such as acetone, methyl ethyl ketone or 2-methyl-2-hydroxypentan-4-one, ethers, such as tetrahydrofuran or dioxane, mono-, oligo- or polyalkylene glycols or thioglycols having C₂-C₆-alkylene units, such as ethylene glycol, 1,2-propylene glycol or 1,3-propylene glycol, 1,2-butylene glycol, 1,4 butylene glycol, neopentylglycol, 1,6-hexanediol, diethylene glycol, triethylene glycol, dipropylene glycol, thiodiglycol, polyethylene glycol or polypropylene glycol, other polyols, such as glycerol or 1,2,6-hexanetriol, C₁-C₄-alkyl ethers of polyhydric alcohols, such as ethylene glycol monomethyl ether, ethylene glycol monoethyl ether, diethylene glycol monomethyl ether, diethylene glycol monoethyl ether, diethylene glycol monobutyl ether (butyldiglycol) or triethylene glycol monomethyl or monoethyl ether, C₁-C₄-alkyl esters of polyhydric alcohols, γ-butyrolactone or dimethyl sulfoxide. Useful solubilizing additives further include lactams, such as caprolactam, 2-pyrrolidinone or N-methyl-2-pyrrolidinone, urea, cyclic ureas, such as 1,3-dimethylimidazolidin-2-one or 1 3-dimethylhexahydropyrimid-2-one and also polyvinylamides, polyvinyl acetates, polyvinyl alcohols, polyvinylpyrrolidones, polysiloxanes or copolymers of the respective monomers. It is similarly possible to use oligomers of ethylene oxide or of propylene oxide or derivatives of these oligomers.

Preferred solubilizing additives are ureas, mono-, di- or triethanolamine, caprolactam, mono-, di- or trialkylene glycols having C₂-C₅-alkylene units and/or oligo- and polyalkylene glycols having ethylene and/or propylene units and also their C₁-C₄-alkyl ethers and C₁-C₄-alkyl esters. Very particular preference is given to ethylene glycol, 1,2-propylene glycol, 1,3-propylene glycol, neopentylglycol, butyldiglycol, alkylpolyethylene glycols, (MW 200-500), ureas and caprolactam.

Preferred liquid formulations comprise essentially
10% to 30% by weight of basic azo dyes (based on the dye without counterion)
0% to 30% by weight of solubilizing additives
   based on the total amount of the aqueous liquid formulation. Particular preference is given to liquid formulations which comprise essentially from 10% to 30% by weight of basic azo dyes and from 1% to 30% by weight and preferably from 1% to 10% by weight of solubilizing additives specifically ethylene glycol, 1,2-propylene glycol, 1,3-propylene glycol, neopentylglycol, butyldiglycol, alkylpolyethylene glycols (MW 200-600), ureas and/or caprolactam.

The present invention's liquid formulations are notable for excellent stability in storage. The liquid formulations are useful inter alia for dyeing and printing cellulosic fiber materials such as wood-containing and wood-free paper materials.

The process according to the present invention provides ready-for-sale liquid formulations of basic azo dyes that enable dyebaths to be prepared directly, simply by diluting with water. The liquid formulations have a low salt content. The process of the present invention obviates the isolation of solids and makes it possible to produce stable low-salt liquid formulations.

The examples which follow illustrate the invention. Parts are by weight, unless otherwise stated.

### EXAMPLE

To a mixture of 74 parts of formic acid (>99% by weight) and 160 parts of water were added 577 parts of ice, so that the temperature was about 0-5° C. This was followed by the simultaneous metered addition, within 120 min, of a solution of 219.6 parts of m-phenylenediamine (m-PDA) in 400 parts of water and 192.2 parts of acetic acid (>99% by weight) on the one hand and 459.5 parts of an aqueous sodium nitrate solution (23% by volume) on the other. The reaction mixture was vigorously stirred during the addition and held at a temperature between 10 and 15° C. by addition of a total of 1154 parts of ice. On completion of the addition the mixture was allowed to warm to 40° C. and stirred at 40° C. for 3 h. A clarifying filtration (filtration residue <0.3% by weight) left 3230 parts of a crude dye solution which was used as starting material for membrane filtration.

The membrane filtration was carried out using a ceramic multichannel element (19 channels 3.5 mm in internal diameter) of a ceramic nanofiltration membrane (0.9 nm TiO₂, from Inocermic). The solution was initially diafiltered at a transmembrane pressure of 25 bar, a temperature of 40° C. and a flow velocity of about 1.4 m/s in the channels. The removed permeate was replaced by continuous, level-regulated addition of an aqueous acetic acid solution as diafiltration medium. In total, 3.9 times the amount of the originally fed mass of crude dye solution was removed as permeate. After diafiltration, the dye concentration was 7.1% by weight. The formate and acetate concentrations were 0.6% by weight and 5.0% by weight respectively. Subsequently, the remaining retentate was concentrated by a factor of 2.2 on the same membrane under identical conditions. After concentration, the dye concentration was 15.5% by weight. The formate and acetate concentrations were 1.1% by weight and 7.2% by weight respectively.

1. A process for producing a liquid formulation of a basic azo dye from a phenylenediamine I, which may be alkyl or alkoxy substituted, by diazotizing and coupling in acidic solution, which comprises diazotizing the phenylenediamine with sodium nitrite in the presence of at least two organic acids comprising at least one first acid (A) having a pk_{A} value of ≦4.0 and at least a second acid (B) having a pK_{A} value ≧4.1 and performing a nanofiltration after the coupling has ended.

2. The process according to claim 1 wherein the acid (A) is formic acid or methanesulfonic acid.

3. The process according to claim 1 wherein the acid (B) is an optionally substituted C₂-C₄ alkanoic acid.

4. The process according to claim 1 wherein the acid (B) is acetic acid.

5. The process according to claim 1 wherein the reaction mixture comprises at least 80 mol % of acid (A), based on the total amount of acid, at the start of the diazotization.

6. The process according to claim 1 wherein the fraction of acid (A) is 20 to 50 mol % based on the total amount of acid used (A+B).

7. The process according to claim 1 wherein the acid (B) is metered into the reaction mixture together with the phenylenediamine I and concurrently to the diazotizing agent.

8. A process for dyeing paper, leather or anionically modified fibers, comprising treating same with a liquid formulation formed by the process of claim 1.
